(19) United States
(12) Patent Application Publication
(10) Pub. No.: US 2024/0412399 A1
(43) Pub. Date: Dec. 12, 2024

(54) Method and System for Utilizing Virtual Cameras in Point Cloud Environments to Support Computer Vision Object Recognition

(71) Applicant: The United States of America as represented by the Secretary of the Navy, San Diego, CA (US)

(72) Inventors: Adrian Mai, Huntsville, AL (US); Mark Bilinski, Vista, CA (US); Raymond Chey Provost, San Diego, CA (US)

(73) Assignee: The United States of America as represented by the Secretary of the Navy, San Diego, CA (US)

(21) Appl. No.: 18/332,984

(22) Filed: Jun. 12, 2023

(51) Int. Cl. G06T 7/70; G06T 5/00; G06T 17/00; G06V 10/25

(52) U.S. Cl. CPC G06T 7/70; G06T 5/70; G06T 17/00; G06V 10/25; G06T 2207/20132; G06V 2201/07

(57) ABSTRACT

A Method and System for Utilizing Virtual Cameras in Point Cloud Environments to Support Computer Vision Object Recognition. More specifically, a method of object recognition with a virtual camera, comprising providing a three-dimensional point cloud and an associated two-dimensional panoramic image, each comprising at least one object of interest, constructing a one-to-one grid map, performing detection and localization on the object of interest, constructing a 3D bounding box around the object of interest, forming a virtual camera system around the bounding box oriented towards the object of interest, rotating the virtual camera around the bounding box, calculating a recognition score for each of the plurality of synthetic images, determining a best angle based on the recognition score, generating a best synthetic image based on the best angle, and obtaining an object recognition prediction based on the best synthetic image. Additionally, a method of text recognition with a virtual camera.

### STATEMENT REGARDING FEDERALLY-SPONSORED RESEARCH AND DEVELOPMENT

The United States Government has ownership rights in this invention. Licensing inquiries may be directed to Office of Research and Technical Applications Naval Information Warfare Center Pacific, Code 72120, San Diego, CA, 92152; telephone (619) 553-5118; email: niwc_patent.fct@us.navy.mil, referencing Navy Case No. 113,673.

### BACKGROUND

The present invention relates to three-dimensional (3D) text recognition and localization from point clouds via two-dimensional (2D) projection and virtual camera. Text detection and recognition is an active field of innovation. In particular, optical character recognition (OCR) has become a common place task in computer vision and is available in off-the-shelf packages. However, such packages still have difficulty with image distortion (e.g. skewed angels or out of focus text). Attempts have been made to solve this problem with extracting geometric features. In facial recognition, for example, the imbedding process involves comparing an anchor image to negative and positive examples. After encoding the features, a decision can be rendered on whether it is the same face. While these methods improve accuracy, they are computationally expensive. There is a need for an object or text recognition method that is capable of process challenging targets of interest, while remaining computationally efficient.

### SUMMARY

According to illustrative embodiments, a method of object recognition with a virtual camera, comprising providing a three-dimensional (3D) point cloud and an associated two-dimensional (2D) panoramic image, each comprising at least one object of interest, constructing a one-to-one grid map, wherein each point in the 3D point cloud correlates with a pixel in the 2D panoramic image, performing detection and localization on the object of interest, constructing a 3D bounding box around the object of interest, forming a virtual camera system around the bounding box oriented towards the object of interest, rotating the virtual camera around the bounding box, wherein the virtual camera generates a plurality of synthetic images at discrete rotation angles by orthogonal projection, calculating a recognition score for each of the plurality of synthetic images, determining a best angle based on the recognition score, generating a best synthetic image based on the best angle, and obtaining an object recognition prediction based on the best synthetic image.

Additionally, a method of text recognition with a virtual camera, comprising receiving a three-dimensional (3D) point cloud data set, detecting and locating a bullseye within the 3D point cloud, wherein the bullseye comprises text having a standardized format, calculating a two-dimensional (2D) bounding box around the bullseye, constructing a one-to-one grid map, wherein each pixel in the 2D bounding box correlates with a point in the 3D point cloud, forming a virtual camera system oriented towards the bullseye in the 3D point cloud, rotating the virtual camera around the object of interest while generating a plurality of images, wherein each image is associated with a rotated virtual camera position, calculating a recognition score for each of the plurality of images, determining a best image and a best position based on the recognition score, generating a synthetic image based on the best image, and obtaining a final text recognition prediction based on the synthetic image.

It is an object to provide A Method and System for Utilizing Virtual Cameras in Point Cloud Environment to Support Computer Vision Object Recognition that offers numerous benefits, including improving accuracy for object and/or text recognition, reducing the computing needs for recognition, and expanding the range of valid targets of interest with an image or 3D point cloud.

It is an object to overcome the limitations of the prior art.

These, as well as other components, steps, features, objects, benefits, and advantages, will now become clear from a review of the following detailed description of illustrative embodiments, the accompanying drawings, and the claims.

### BRIEF DESCRIPTION OF THE DRAWINGS

The accompanying drawings, which are incorporated in and form a part of the specification, illustrate example embodiments and, together with the description, serve to explain the principles of the invention. Throughout the several views, like elements are referenced using like references. The elements in the figures are not drawn to scale and some dimensions are exaggerated for clarity. In the drawings:

FIG. 1 is an exemplary flow-chart diagram of a method of object recognition with a virtual camera.

FIG. 2 shows an exemplary computer vision system and method comprising an object of interest, virtual camera, and image plane.

FIG. 3 shows an illustration of one embodiment of rotating the virtual camera around the object of interest, comprising an object of interest, virtual camera, a plurality of images, and a best angle.

FIG. 4A shows an exemplary point cloud and a plurality of rotation angles.

FIG. 4B shows the results of the plurality of images taken by the virtual camera positioned in FIG. 4A.

FIG. 5A shows an exemplary virtual camera system.

FIG. 5B shows two exemplary raw images and virtual camera produced (synthetic) images.

### DETAILED DESCRIPTION OF EMBODIMENTS

The disclosed system and method below may be described generally, as well as in terms of specific examples and/or specific embodiments. For instances where references are made to detailed examples and/or embodiments, it should be appreciated that any of the underlying principles described are not to be limited to a single embodiment, but may be expanded for use with any of the other system and methods described herein as will be understood by one of ordinary skill in the art unless otherwise stated specifically.

References in the present disclosure to “one embodiment,” “an embodiment,” or any variation thereof, means that a particular element, feature, structure, or characteristic described in connection with the embodiments is included in at least one embodiment. The appearances of the phrases “in one embodiment,” “in some embodiments,” and “in other embodiments” in various places in the present disclosure are not necessarily all referring to the same embodiment or the same set of embodiments.

As used herein, the terms “comprises,” “comprising,” “includes,” “including,” “has,” “having,” or any variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or.

Additionally, use of words such as “the,” “a,” or “an” are employed to describe elements and components of the embodiments herein; this is done merely for grammatical reasons and to conform to idiomatic English. This detailed description should be read to include one or at least one, and the singular also includes the plural unless it is clearly indicated otherwise.

Despite growing bodies of research focusing on 2D text detection and optical character recognition (OCR), these tasks in 3D spaces are still relatively new to the computer vision community due to limited 3D data resources. Current public 3D datasets often focus on applications such as autonomous driving or interior structure. Previously, the US Navy provided a new and unique 3D dataset made up of shipboard 3D scans and used it for the purpose of text detection. Here, the disclosed systems and methods to the text of bullseyes, text placards that help Sailors navigate ships. This may, in one embodiment, enable interior shipboard navigation in robotic and augmented reality applications.

The lack of training datasets and computational complexity of 3D dimensions make text localization and recognition in point cloud environments challenging tasks, resulting in them being relatively undeveloped topics in the research community. Here, we introduce methods and systems to adapt 2D text detection and recognition techniques in panoramic images with appropriate 3D mapping. This, combined with heuristic methods such as a virtual camera, creates a fast and efficient 3D text localization and recognition system. In real world applications, the objects of interest for a computer vision task may not be captured by the sensor from an ideal perspective; instead skewed imagery or partial occlusions are common. In a virtual 3D environment, an operator has full control of viewing angles and distances from the object. Therefore, by placing a virtual camera in certain positions, one can generate synthetic imagery of the object that is based on real imagery and avoids skewed views or occlusions. This synthetic imagery may be used to improve the performance of text recognition when the object of interest is sufficiently close to the scanner, and hence the point density is high enough to generate quality imagery. This system and method is attractive and computationally inexpensive as it uses 2D data processes instead of natively 3D. In one embodiment, the system shows promising results in testing with over 85% accuracy for detection and localization tasks and 80% on the recognition task.

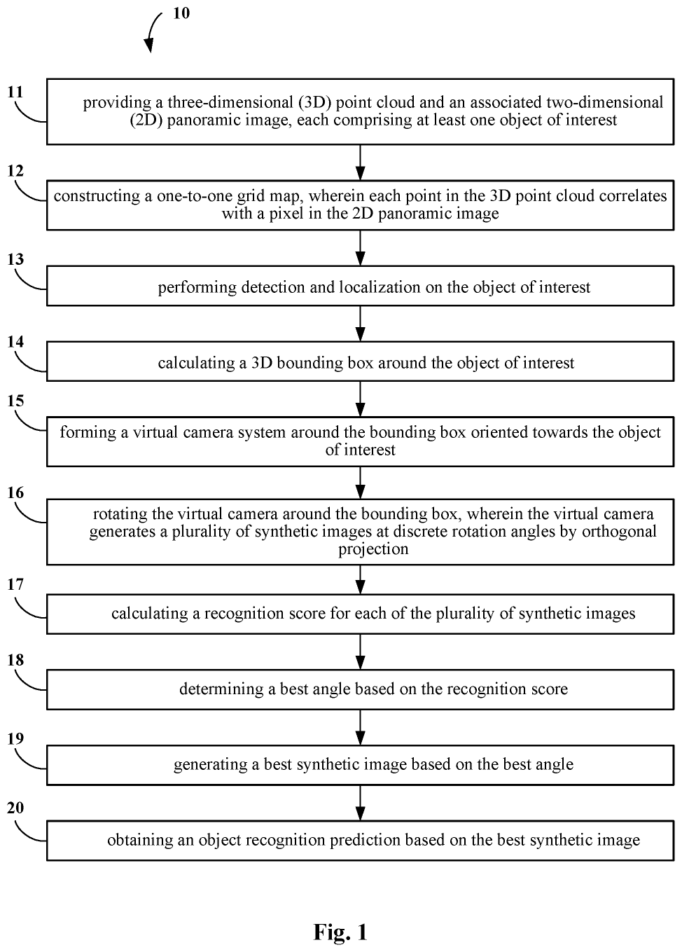

FIG. 1 is a method of object recognition with a virtual camera 10, comprising: providing a three-dimensional (3D) point cloud and an associated two-dimensional (2D) panoramic image, each comprising at least one object of interest 11; constructing a one-to-one grid map, wherein each point in the 3D point cloud correlates with a pixel in the 2D panoramic image 12; performing detection and localization on the object of interest 13; constructing a 3D bounding box around the object of interest 14; forming a virtual camera system around the bounding box oriented towards the object of interest 15; rotating the virtual camera around the bounding box, wherein the virtual camera generates a plurality of synthetic images at discrete rotation angles by orthogonal projection 16; calculating a recognition score for each of the plurality of synthetic images 17; determining a best angle based on the recognition score 18; generating a best synthetic image based on the best angle 19; and determining a recognition prediction based on the best synthetic image 20.

Providing a 3D point cloud and an associated 2D panoramic image, each comprising at least one object of interest 11 may comprise a LiDAR point clouds and a 2D panoramic image, which may have also been (extrapolated from the LiDAR point could, and a plurality of objects of interest including, but not limited to, physical objects, images, or text.

Furthermore, in the step of constructing a one-to-one grid map, wherein each point in the 3D point cloud correlates with a pixel in the 2D panoramic image 12, the 2D text detections are mapped to the 3D space using a grid mapping algorithm. The grid construction is a one-to-one mapping based on the principle of spherical projection, and allows for the construction of a 2D RGB panoramic image from the 3D point cloud, and vice versa. Since each 2D pixel has a corresponding point in 3D through this grid mapping, we can use the 2D midpoint of a bullseye to find the 3D centroid of its 3D bounding box. The algorithmically determined 3D centroid is compared against the manually annotated ground truth via simple distance metric.

In one embodiment, one may crop all points within about 0.5 m of the centroid as the target point cloud for further processing; this provides a smaller area for the optical character recognition. This target point cloud's normal vector determines the orientation of the bounding box

In one embodiment, the grid mapping algorithm further comprises mapping the distance return values to the 2D panoramic image; projecting the 2D panoramic image onto a cube map detecting the target objects within the 2D panoramic image; generating target object data for individual boxes of the cube map; and mapping the target object data to the 2D panoramic image and 3D point cloud.

In one embodiment, the systems and methods may assume bullseyes are flat (i.e. on a wall). Plane estimation may be performed, for example, by using Open3D's random sample consensus (RANSAC) algorithm from which the normal vector is then calculated. After plane estimation, points close enough to belong to that plane are selected. For example, within a distance threshold of 2 mm may be used for selection. The difference in angle between the algorithmically determined normal vector and the ground truth may also be calculated.

Furthermore, additional techniques may be required to localize and recognize objects of interest located on curved surfaces. Curved surfaces may utilize the determination of an ideal normal vector. An ideal normal vector may be determined by testing a range of viable distances and normal vector angles. Testing and evaluating normal vectors may be done with a variety of detection and OCR algorithms to find a strong combination. Optimally, a method of recognition has a high accuracy, precision, and recall percentage. For example, the following text or OCR algorithms may be used: Paddle, Efficient and Accurate Scene Text (EAST), Character Region Awareness for Text (CRAFT), and Attentional Scene Text Recognizer with Flexible Rectification (ASTER). The distance metric may be optimized by comparing it with the algorithmically determined 3D centroid extrapolated from one-to-one grid mapping. Additionally, normal vector angel angle may be optimized by comparing the algorithmically determined normal vector and the ground truth for each algorithm combination. In one embodiment, a final algorithm, or combination of algorithms, may be selected by considering three metrics: binary confusion matrix, 3D centroid distance, and normal vector angle. Using these metrics, a resulting algorithm, for example, may be a combination of CRAFT and ASTER.

Several challenges may exist with the 2D to 3D mapping step. First, when the 2D bullseye center is mapped to 3D, there is the potential for the mapped point to be empty; e.g. result of a reflective surface, noise, etc. An empty point may be automatically assigned by the scanner to have coordinate (x, y, z)=(0, 0, 0), causing our prediction bounding box to move to the origin instead of its correct location. To solve this issue, all empty points in the grid may first be removed, then if the centroid is empty, the next closest non-zero 2D point in the new 3D grid is used instead. The second challenge may be the presence of noisy point clouds; more specifically, noisy data caused by reflective surfaces. This is especially prevalent in modern blue text bullseyes. In an exemplary test case, the point cloud of a given section of wall may have a fairly high point density. In this example, about 10-30 points clustered in a 2 cm radius. The density is dependent on the distance between the LiDAR scanner and the wall.

The following is an exemplary method of reducing noise. Since noise will typically have a lower density, one may determine if the calculated centroid is part of such noise. First, the point cloud may be down sampled 100 times; then for each mapping point in 3D, one may create a norm ball with a radius of 5 cm. If the density of points in that norm ball is less than 10 points, it is assumed to be noise and the process is repeated until the point density exceeds 10.

Performing detection and localization on the object of interest 13 comprising identifying a position of at least one object of interest in the 3D point cloud or 2D panoramic image. For example, object detection may be performed on a 2D flattened panoramic image in conjunction with the LiDAR point clouds. In one embodiment, detection and localization is performed on the 3D point cloud. In another embodiment, detection and localization is performed on the 2D panoramic image, and utilizes the grid map to extrapolate the 2D localization to a 3D localization.

Calculating a 3D bounding box around the object of interest 14 may define the target, which is the object of interest 100. As discussed previously, one exemplary object of interest 100 may be text. In this case, recognition engines may be prone to error when the viewing angle of the object or text is distorted. This effect is exacerbated in panoramas. In order to aid the recognition process, we introduce a virtual camera method to consider a synthetic image 200 taken from a more ideal perspective, directly in front of and directly facing the bullseye. This method uses orthographic projection to create a synthetic image 200 that magnifies and flattens the panoramic region at the centroid of each cluster. In one embodiment, calculating a bounding box around the object of interest further comprises determining a 2D midpoint of the object of interest, mapping the 2D midpoint to the 3D point cloud via the grid map, calculating a 3D centroid of the object of interest, and cropping the 3D point cloud to a fixed distance of the 3D centroid, wherein the fixed distance enables efficient processing. In another embodiment, calculating a bounding box around the object of interest further comprises calculating a normal vector of the bounding box, and wherein the virtual camera system's orientation is opposite a normal vector of the bounding box.

In one embodiment, the object of interest 100 may be standardized assemblies of text called “bullseyes”. Specifically, bullseyes consist of three lines of alphanumeric text. In this example concerning bullseyes, a hierarchical clustering distance method may be used to eliminate false detects or standalone text that does not meet this known standardized format. Remaining text instances may then be fed into a classification model to determine if the detect is a true bullseye or other text in the scene. For the text classifier, one may use character embeddings instead of word embeddings to encode each character differently—as the text in bullseyes do not form words. To train this network, for example, one may create a synthetic dataset containing five categories: random text, English words, first line, second line, and last line of the bullseye. This “bullseye” dataset is based on standards set by the US Navy. This approach to bullseyes is exemplary for method which allow a preliminary determine of whether the object of interest 100 is valid.

Forming a virtual camera system around the bounding box oriented towards the object of interest 15 may assist in recognition of images, even after flatting, magnification, and/or perspective projection. A virtual camera 200 may be used in the 3D domain to create a synthetic image of the area of interest from a new perspective. The point cloud area of interest may be cropped using the centroid, then the virtual camera 200 is placed at a fixed distance from the centroid along the normal. Given 3D point world coordinates matrix P_{w}, rotation matrix R (defined by the target bounding box), and camera location x_{C}, one may transform the world system to the camera system by P_{c}=R*(P_{w}−x_{C}). The camera now may be positioned at the optimal location, looking directly at the bullseye.

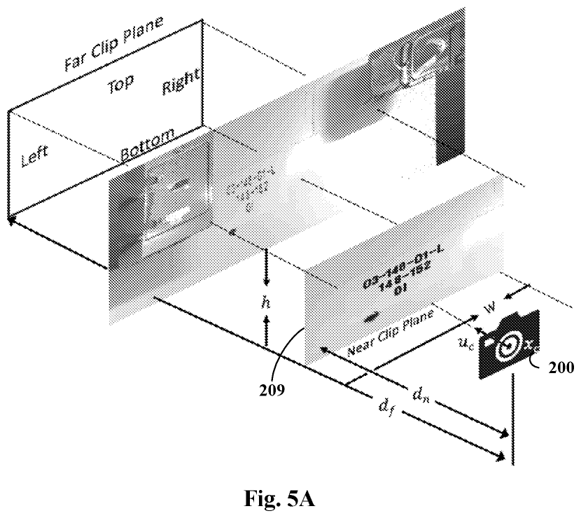

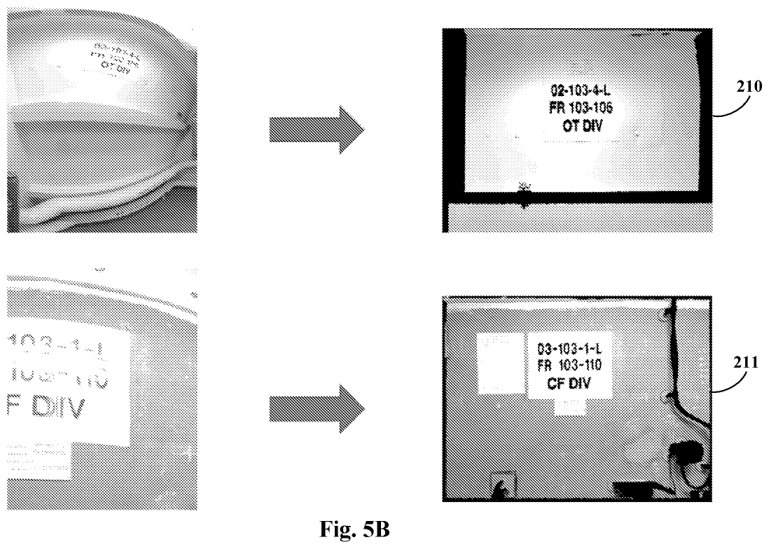

Rotating the virtual camera around the bounding box, wherein the virtual camera generates a plurality of synthetic images at discrete rotation angles by orthogonal projection 16 may improve recognition. The points from the camera frame may be transformed to the image frame using orthographic projection. Consider the transform matrix Tₘ shown in Equation 1, the variables dₙ and d_{f} are defined as the distance from the camera to the near and far planes respectively. The resulting exemplary coordinates in the image plane are given in Equation 2, where the subscripts i and c denote image frame and camera frame, and variables u and v give the horizontal and vertical grid for each pixel in the synthetic image 201-208. Each pixel may then be mapped to its associated color pixel, thus generating a flat colorized synthetic image 201-208 centered on the bullseye. FIG. 5A shows the virtual camera 200 system comprising a synthetic image 209 and FIG. 5B shows two examples compared raw skewed images and virtual camera 200 produced synthetic images 210-211.

$${T}_{m} = [ \begin{matrix}2 \frac{{d}_{n}}{w} & 0 & 0 & 0 \\ 0 & 2 \frac{{d}_{n}}{h} & 0 & 0 \\ 0 & 0 & \frac{{d}_{n} + {d}_{f}}{{d}_{n} - {d}_{f}} & \frac{2 {d}_{n} {d}_{f}}{{d}_{n} - {d}_{f}} \\ 0 & 0 & 1 & 0\end{matrix} ] \qquad Equation 1$$

$$u = \frac{- {x}_{c}}{{z}_{i}} ; = \frac{- {y}_{c}}{{z}_{i}} ; {P}_{i} = {T}_{m} {P}_{c} ; {z}_{i} = \frac{{d}_{n} + {d}_{f}}{{d}_{n} - {d}_{f}} {z}_{c} + \frac{2 {d}_{n} {d}_{f}}{{d}_{n} - {d}_{f}} \qquad Equation 2$$

Calculating a recognition score for each of the plurality of synthetic images 17 and determining a best angle based on the recognition score 18 may enable generating a best synthetic image based on the best angle 19 for improved recognition. The images collected by the virtual camera 200 may be fed into the recognition engine to compute their recognition score. The rotation scheme may be defined by rotating around a non-major axis (axis that is pointed vertically in the image) along with the given angle until it gets back to the original position. The angle resulting in the image (image angle) with the highest recognition score may be saved along with the synthetic image 201 that it captured. That synthetic image 201 may, for example, be sent through the text recognition module to obtain a final object or text recognition prediction. In other words, obtaining an object recognition prediction based on the best synthetic image.

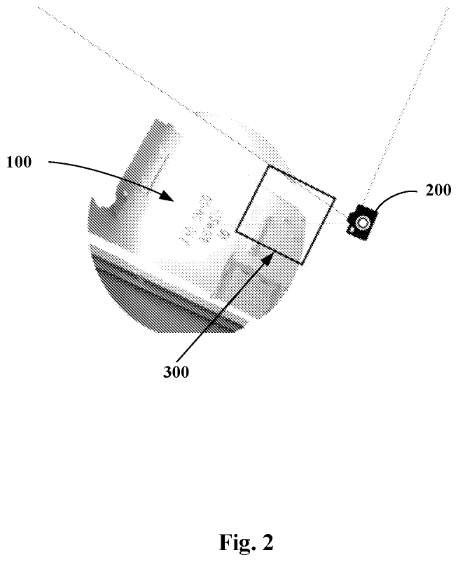

FIG. 2 shows an exemplary computer vision system and method comprising an object of interest 100, virtual camera 200, and image plane 300. The exemplary object of interest 100 is shown as text, but is not so limited. This text is an example of a bullseye, as discussed previously, because of its standardized format. Moreover, this object of interest 100 is a target that is well-suited for the disclosed system and method, because it is blurry. The virtual camera 200 has been placed directly facing the object of interest 100. Additionally, the virtual camera 200 may be within a coordinate system associated with the image plane 300. In one embodiment, the virtual camera 200 is at the origin of a coordinate system associated with image plane 300. In one embodiment, the virtual camera 200 is oriented parallel to the normal direction of the object of interests 2D bounding box.

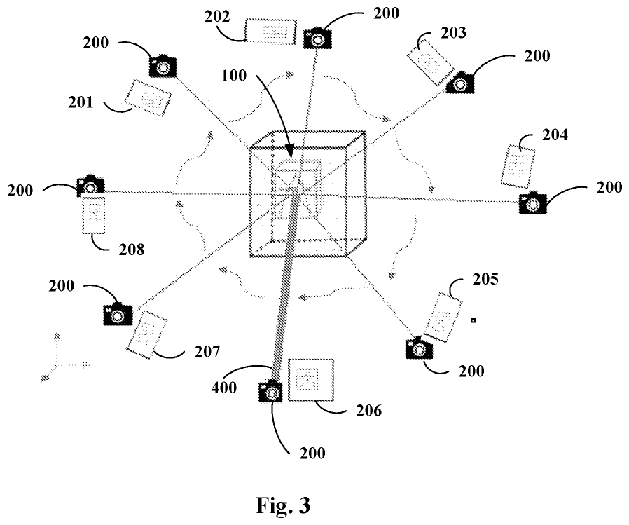

FIG. 3 shows an illustration of one embodiment of rotating the virtual camera around the object of interest 100, comprising an object of interest, virtual camera 200, a plurality of images 201-208, and a best angle 400. The object of interest 100 has been extracted from the point cloud, in this example. Moreover, the object of interest 100 is also within a 3D bounding box, as indicated by the green outline. FIG. 3 also shows an exemplary case of eight synthetic images 201-208 taken by a virtual camera 200 at 8 discrete angles around the object of interest 100. As shown in FIG. 3, each synthetic image 201-208 provides a unique view of the object of interest 100. A best angle may then be determined by calculating a recognition score with a recognition engine. A high recognition score may indicate that the synthetic image 201-208 has a high probability of accurate recognition.

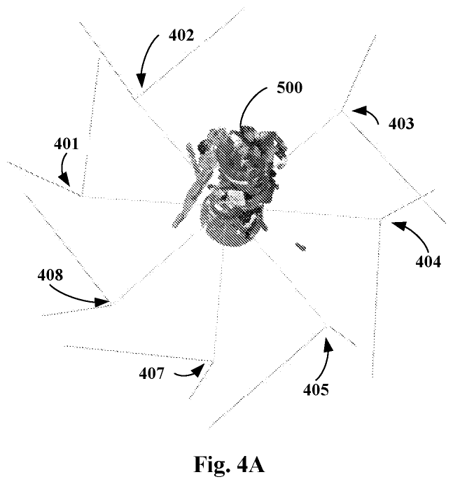

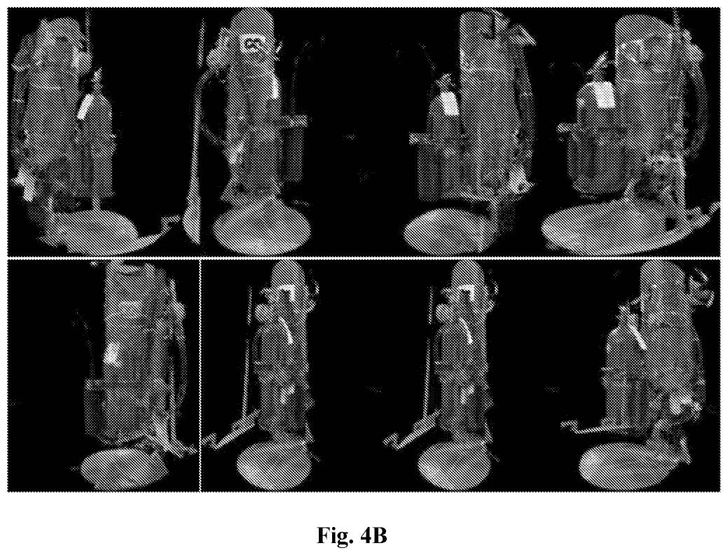

FIG. 4A shows an exemplary point cloud 500 and a plurality of rotation angles 401-409. Here, the exemplary point cloud 500 comprises a fire extinguisher with text that may be an object of interest 100. A virtual camera 200 may be utilized at each of the rotation angles to determine a best angle 400 and image.

FIG. 4B shows the results of the plurality of images taken by the virtual camera 200 positioned in FIG. 4A. These images captured from the virtual camera 200 may be called synthetic images 201-208.

As discussed previously, FIG. 5A shows an exemplary virtual camera system comprising a virtual camera 200 and synthetic image 209. FIG. 5B shows two exemplary raw images and virtual camera produced (synthetic) images 201-209. Any of the plurality of synthetic images 201-209 may be identified as a best synthetic image. The best synthetic image is one of the plurality of synthetic images 201-209 that highest accuracy, precision, and/or recall percentage. The best synthetic image correlates with a best angle and may participate in obtaining a recognition prediction.

From the above description of A Method and System for Utilizing Virtual Cameras in Point Cloud Environment to Support Computer Vision Object Recognition, it is manifest that various techniques may be used for implementing the concepts of a method of object recognition with a virtual camera and a method of text recognition with a virtual camera without departing from the scope of the claims. The described embodiments are to be considered in all respects as illustrative and not restrictive. The method/system disclosed herein may be practiced in the absence of any element that is not specifically claimed and/or disclosed herein. It should also be understood that a method of object recognition with a virtual camera and a method of text recognition with a virtual camera are not limited to the particular embodiments described herein, but is capable of many embodiments without departing from the scope of the claims.

What is claimed:

1. A method of object recognition with a virtual camera, comprising:
providing a three-dimensional (3D) point cloud and an associated two-dimensional (2D) panoramic image, each comprising at least one object of interest;
constructing a one-to-one grid map, wherein each point in the 3D point cloud correlates with a pixel in the 2D panoramic image;
performing detection and localization on the object of interest;
constructing a 3D bounding box around the object of interest;
forming a virtual camera system around the bounding box oriented towards the object of interest;
rotating the virtual camera around the bounding box, wherein the virtual camera generates a plurality of synthetic images at discrete rotation angles by orthogonal projection;
calculating a recognition score for each of the plurality of synthetic images;
determining a best angle based on the recognition score;
generating a best synthetic image based on the best angle; and
obtaining an object recognition prediction based on the best synthetic image.

2. The method of object recognition with a virtual camera of claim 1, wherein detection and localization is performed on the 3D point cloud.

3. The method of object recognition with a virtual camera of claim 1, wherein detection and localization is performed on the 2D panoramic image, and utilizes the grid map to extrapolate the 2D localization to a 3D localization.

4. The method of object recognition with a virtual camera of claim 1, wherein calculating a bounding box around the object of interest further comprises:
determining a 2D midpoint of the object of interest;
mapping the 2D midpoint to the 3D point cloud via the grid map;
calculating a 3D centroid of the object of interest; and
cropping the 3D point cloud to a fixed distance of the 3D centroid, wherein the fixed distance enables efficient processing.

5. The method of object recognition with a virtual camera of claim 1, further comprising:
calculating an ideal normal vector of the object of interest; and
wherein the virtual camera system's orientation is opposite a normal vector of the bounding box.

6. The method of object recognition with a virtual camera of claim 1, further comprising:
down-sampling the 3D point cloud;
removing a plurality of points in a low-density region of the 3D point cloud to reduce noise.

7. The method of object recognition with a virtual camera of claim 1, wherein the virtual camera is oriented towards the object of interest in the 3D point cloud according to the following equation: P_{c}=R*(P_{w}−x_{C}).

8. The method of object recognition with a virtual camera of claim 1, wherein orthographic projection utilizes the transformation matrix having the following equation:
$${T}_{m} = [ \begin{matrix}2 \frac{{d}_{n}}{w} & 0 & 0 & 0 \\ 0 & 2 \frac{{d}_{n}}{h} & 0 & 0 \\ 0 & 0 & \frac{{d}_{n} + {d}_{f}}{{d}_{n} - {d}_{f}} & \frac{2 {d}_{n} {d}_{f}}{{d}_{n} - {d}_{f}} \\ 0 & 0 & 1 & 0\end{matrix} ] .$$

9. The method of object recognition with a virtual camera of claim 5, wherein the transformed coordinates are determined by the following equations:
$$u = \frac{- {x}_{c}}{{z}_{i}} ; v = \frac{- {y}_{c}}{{z}_{i}} ; {P}_{i} = {T}_{m} {P}_{c} ; \\ {z}_{i} = \frac{{d}_{n} + {d}_{f}}{{d}_{n} - {d}_{f}} {z}_{c} + \frac{2 {d}_{n} {d}_{f}}{{d}_{n} - {d}_{f}} .$$

10. The method of object recognition with a virtual camera of claim 1, further comprising:
generating synthetic data training set from the point cloud data set.

11. A method of text recognition with a virtual camera, comprising:
receiving a three-dimensional (3D) point cloud data set;
detecting and locating a bullseye within the 3D point cloud, wherein the bullseye comprises text having a standardized format;
calculating a two-dimensional (2D) bounding box around the bullseye;
constructing a one-to-one grid map, wherein each pixel in the 2D bounding box correlates with a point in the 3D point cloud;
forming a virtual camera system around the bounding box oriented towards the bullseye in the 3D point cloud;
rotating the virtual camera around the bounding box, wherein the virtual camera generates a plurality of synthetic images at discrete rotation angles by orthogonal projection;
calculating a recognition score for each of the plurality of images;
determining a best image and a best position based on the recognition score;
generating a synthetic image based on the best image; and
obtaining a final text recognition prediction based on the synthetic image.

12. The method of text recognition with a virtual camera of claim 11, wherein detecting and locating the bullseye further comprises:
utilizing a hierarchical clustering distance method to eliminate text that does not meet the standardized format.

13. The method of text recognition with a virtual camera of claim 11, further comprising:
differentiating between text within the bullseye and unwanted text with a text classification model.

14. The method of object recognition with a virtual camera of claim 11, further comprising:
extrapolating a 3D bounding box from the 2D bounding box;
determining a centroid of a 3D bounding box;
cropping the point cloud area to within about 0.5 meters of the centroid;
performing plane estimation on the 3D bounding box; and
determining a normal vector of the 3D bounding box based on the plane estimation.

15. The method of text recognition with a virtual camera of claim 11, further comprising:
calculating an ideal normal vector of the object of interest; and
wherein the virtual camera system's orientation is opposite a normal vector of the bounding box.

16. The method of text recognition with a virtual camera of claim 11, further comprising:
down-sampling the 3D point could;
removing a plurality of points in a low-density region of the 3D point cloud to reduce noise.

17. The method of text recognition with a virtual camera of claim 11, wherein the virtual camera is oriented towards the object of interest in the 3D point cloud according to the following equation: P_{c}=R*(P_{w}−x_{C}).

18. The method of text recognition with a virtual camera of claim 11, wherein orthographic projection utilizes the transformation matrix having the following equation:
$${T}_{m} = [ \begin{matrix}2 \frac{{d}_{n}}{w} & 0 & 0 & 0 \\ 0 & 2 \frac{{d}_{n}}{h} & 0 & 0 \\ 0 & 0 & \frac{{d}_{n} + {d}_{f}}{{d}_{n} - {d}_{f}} & \frac{2 {d}_{n} {d}_{f}}{{d}_{n} - {d}_{f}} \\ 0 & 0 & 1 & 0\end{matrix} ] .$$

19. The method of text recognition with a virtual camera of claim 11, wherein the transformed coordinates are determined by the following equations:
$$u = \frac{- {x}_{c}}{{z}_{i}} ; v = \frac{- {y}_{c}}{{z}_{i}} ; {P}_{i} = {T}_{m} {P}_{c} ; \\ {z}_{i} = \frac{{d}_{n} + {d}_{f}}{{d}_{n} - {d}_{f}} {z}_{c} + \frac{2 {d}_{n} {d}_{f}}{{d}_{n} - {d}_{f}} .$$

20. The method of text recognition with a virtual camera of claim 11, further comprising:
generating synthetic data training set from the point cloud data set.
